(19) United States
(12) Patent Application Publication
(10) Pub. No.: US 2026/0246657 A1
(43) Pub. Date: Aug. 20, 2026

(54) CONTROL APPARATUS, FRONTHAUL MULTIPLEXER, CONNECTION SWITCHING METHOD AND MULTIPLEXING METHOD

(71) Applicant: NTT, INC., Tokyo (JP)

(72) Inventors: Hirotaka UJIKAWA, Musashino-shi (JP); Tatsuya SHIMADA, Musashino-shi (JP); Yoshihito SAKAI, Musashino-shi (JP)

(73) Assignee: NTT, Inc, Tokyo (JP)

(21) Appl. No.: 19/489,631

(22) PCT Filed: Jun. 7, 2023
(86) PCT No.: PCT/JP2023/021175

§ 371 Date: Dec. 3, 2025

(51) Int. Cl. H04L 12/12

(52) U.S. Cl. CPC H04L 12/12

(57) ABSTRACT

A control device includes a switching signal transmission unit configured to transmit, to a light distribution unit, a switching signal including an instruction to switch an accommodation destination of a fronthaul multiplexer from a first communication station to a second communication station, and transmit, to the fronthaul multiplexer, a control signal including information on a delay time to be imparted to a multiplex signal by the fronthaul multiplexer so that a delay time does not change before and after the switching of the communication station, the fronthaul multiplexer outputting the multiplex signal, which is obtained by multiplexing signals output from a plurality of terminal accommodation stations communicating with a terminal by adjusting timings of the signals, to a distribution destination via a light distribution unit.

### TECHNICAL FIELD

The present invention relates to a control device, a fronthaul multiplexer, a connection switching method, and a multiplexing method.

### BACKGROUND ART

FIG. 8 is a diagram showing an example of a communication system S of the related art. The communication system S includes a plurality of antenna stations 1-1 and 1-2, a fronthaul multiplexer 2, and an aggregation station 3. The antenna stations 1-1 and 1-2 are radio units (RUs) in a mobile communication system. The aggregation station 3 is a central unit/distributed unit (CU/DU) in the mobile communication system. As shown in FIG. 8, in order to effectively utilize frequency resources in a wireless section and the aggregation station 3 that performs baseband processing, a device referred to as a fronthaul multiplexer (FHM) 2 is disposed between the antenna stations 1-1 and 1-2 installed at different locations.

The fronthaul multiplexer 2 operates in such a manner that the plurality of antenna stations 1-1 and 1-2 connected to the fronthaul multiplexer 2 can be seen as one antenna station when viewed from the aggregation station 3. Specifically, the fronthaul multiplexer 2 performs signal processing on signals corresponding to the same time with respect to uplink signals received from the plurality of antenna stations 1-1 and 1-2 and merges the signals. The time at which each of the uplink signals are received by the fronthaul multiplexer 2 varies depending on a distance between the fronthaul multiplexer 2 and each of the antenna stations 1-1 and 1-2. For this reason, the fronthaul multiplexer 2 imparts a delay corresponding to a distance difference to the received uplink signals, merges the signals, and then performs signal processing thereon. Here, imparting a delay means inserting a delay to the signal to delay it.

FIG. 9 is a diagram showing an outline of processing performed by the fronthaul multiplexer 2. As shown in FIG. 9, it is assumed that an uplink signal transmitted from the antenna station 1-1 reaches the fronthaul multiplexer 2 prior to an uplink signal transmitted from the antenna station 1-2, depending on a distance between the fronthaul multiplexer 2 and each of the antenna stations 1-1 and 1-2. In this case, the fronthaul multiplexer 2 imparts a delay to the uplink signal transmitted from the antenna station 1-1 to adjust the times at which the uplink signals transmitted from the respective antenna stations 1-1 and 1-2 are received. Thereafter, the fronthaul multiplexer 2 generates a multiplex signal by multiplexing the uplink signals transmitted from the respective antenna stations 1-1 and 1-2.

By using the fronthaul multiplexer 2 in this manner, it is possible to reduce a required number of ports of the aggregation station 3 and a required number of fibers between the fronthaul multiplexer 2 and the aggregation station 3. The fronthaul multiplexer 2 adds (or selects) signals received by an antenna (ones obtained by quantizing received power) in the uplink direction and makes the signals look like signals received from one antenna. For this reason, it is necessary to adjust the sampling time so that the sampling time does not deviate during the addition. A fronthaul multiplexer 2 for 5G is also being developed.

FIG. 10 is a diagram showing an example of a communication system Sa of the related art. The communication system Sa includes the plurality of antenna stations 1-1 and 1-2, the fronthaul multiplexer 2, a plurality of aggregation stations 3-1 and 3-2, a light distribution unit 4, a controller 5. FIG. 10 shows processing in a case where the connection of the fronthaul multiplexer 2 is changed to the aggregation station 3-2 depending on the use state of the aggregation station 3-1 (for example, in a case where a traffic amount in the aggregation station 3-1 is extremely small and the accommodation of the antenna stations 1-1 and 1-2 is integrated into the aggregation station 3-2).

In this case, the controller 5 for controlling monitoring can change a connection destination from the fronthaul multiplexer 2 to the aggregation station 3-2 by switching the connection of the light distribution unit 4 with the fact that the traffic amount in the aggregation station 3-1 decreases to a fixed amount or less as a trigger.

### CITATION LIST

### Non Patent Literature

[NPL 1] “Development of Base Station Device for the Introduction of 3.5 GHz Band TD-LTE”, NTT DOCOMO Technical Journal Vol.24 No.2
[NPL 2] “5G Network”, NTT DOCOMO Technical Journal Vol.28 No.2
[NPL 3] “Mobile Fronthaul over APN PoC Reference Version 1.0”, Aug. 29, 2022, IOWN GLOBAL FORUM™

### SUMMARY OF INVENTION

### Technical Problem

However, when an attempt to change the fronthaul multiplexer 2 accommodating the antenna stations 1-1 and 1-2 from the aggregation station 3-1 to the aggregation station 3-2 is made by switching the light distribution unit 4, a distance from the fronthaul multiplexer 2 to the aggregation station 3-1 and a distance from the fronthaul multiplexer 2 to the aggregation station 3-2 vary, resulting in a delay difference. Thereby, link disconnection occurs between the aggregation station 3 and the antenna station 1, and procedures for link establishment including delay measurement are performed again between the aggregation station 3 and the antenna station 1. As a result, there is a problem that communication is interrupted during the period.

In view of the above circumstances, an object of the present invention is to provide technology that makes it possible to reduce a communication interruption time even when a connection destination of a fronthaul multiplexer is changed to a different device.

### Solution to Problem

An aspect of the present invention is a control device including a switching signal transmission unit configured to transmit, to a light distribution unit, a switching signal including an instruction to switch an accommodation destination of a fronthaul multiplexer from a first communication station to a second communication station, and transmit, to the fronthaul multiplexer, a control signal including information on a delay time to be imparted to a multiplex signal by the fronthaul multiplexer so that a delay time does not change between before and after the switching of the communication station, the fronthaul multiplexer outputting the multiplex signal, which is obtained by multiplexing signals output from a plurality of terminal accommodation stations communicating with a terminal by adjusting timings of the signals, to a distribution destination via a light distribution unit.

An aspect of the present invention is a fronthaul multiplexer in a communication system including a plurality of terminal accommodation stations that communicate with a terminal, the fronthaul multiplexer that outputs a multiplex signal obtained by multiplexing signals by adjusting timings of the signals output from the plurality of terminal accommodation stations, and a light distribution unit that outputs the multiplex signal output from the fronthaul multiplexer to a distribution destination, the fronthaul multiplexer including a lower order side delay insertion unit configured to adjust transmission timings of signals output from each of the plurality of terminal accommodation stations, a signal merging unit configured to generate the multiplex signal by multiplexing the signals adjusted by the lower order side delay insertion unit, a switching signal processing unit configured to receive, from the outside, a control signal including information on switching of the light distribution unit and information on a delay time to be imparted to the multiplex signal, and switch a delay value indicated by the information on the delay time to be imparted to the multiplex signal included in the control signal to a delay value to be imparted to the multiplex signal in response to the reception of the control signal, and a higher order side delay insertion unit configured to impart the delay value switched by the switching signal processing unit to the multiplex signal.

An aspect of the present invention is a connection switching method including transmitting, to a light distribution unit, a switching signal including an instruction to switch an accommodation destination of a fronthaul multiplexer from a first communication station to a second communication station, and transmitting, to the fronthaul multiplexer, a control signal including information on a delay time to be imparted to a multiplex signal by the fronthaul multiplexer so that a delay time does not change before and after the switching of the communication station, the fronthaul multiplexer outputting the multiplex signal, which is obtained by multiplexing signals output from a plurality of terminal accommodation stations communicating with a terminal by adjusting timings of the signals, to a distribution destination via a light distribution unit.

An aspect of the present invention is a multiplexing method performed by a fronthaul multiplexer in a communication system including a plurality of terminal accommodation stations that communicate with a terminal, the fronthaul multiplexer that outputs a multiplex signal obtained by multiplexing signals by adjusting timings of the signals output from the plurality of terminal accommodation stations, and a light distribution unit that outputs the multiplex signal output from the fronthaul multiplexer to a distribution destination, the multiplexing method including adjusting transmission timings of signals output from each of the plurality of terminal accommodation stations, generating the multiplex signal by multiplexing the adjusted signals, receiving, from the outside, a control signal including information on switching of the light distribution unit and information on a delay time to be imparted to the multiplex signal, switching a delay value indicated by the information on the delay time to be imparted to the multiplex signal included in the control signal to a delay value to be imparted to the multiplex signal in response to the reception of the control signal, and imparting the switched delay value to the multiplex signal.

### Advantageous Effects of Invention

According to the present invention, even when a connection destination of a fronthaul multiplexer is changed to a different device, it is possible to reduce a communication interruption time.

### BRIEF DESCRIPTION OF DRAWINGS

FIG. 1 A diagram showing a configuration example of a communication system in an embodiment.

FIG. 2 A diagram showing a configuration example of a controller in the embodiment.

FIG. 3 A diagram showing a configuration example of a fronthaul multiplexer in the embodiment.

FIG. 4 A diagram showing a method of calculating a delay time to be imparted in the embodiment.

FIG. 5 A diagram showing the setting timing of a delay time to be imparted in the embodiment.

FIG. 6 A sequence diagram showing a flow of pre-processing performed by a communication system in the embodiment.

FIG. 7 A sequence diagram showing a flow of a switching process performed by the communication system in the embodiment.

FIG. 8 A diagram showing an example of a communication system of the related art.

FIG. 9 A diagram showing an outline of processing performed by a fronthaul multiplexer.

FIG. 10 A diagram showing an example of a communication system of the related art.

### DESCRIPTION OF EMBODIMENTS

Hereinafter, an embodiment of the present invention will be described with reference to the accompanying drawings.

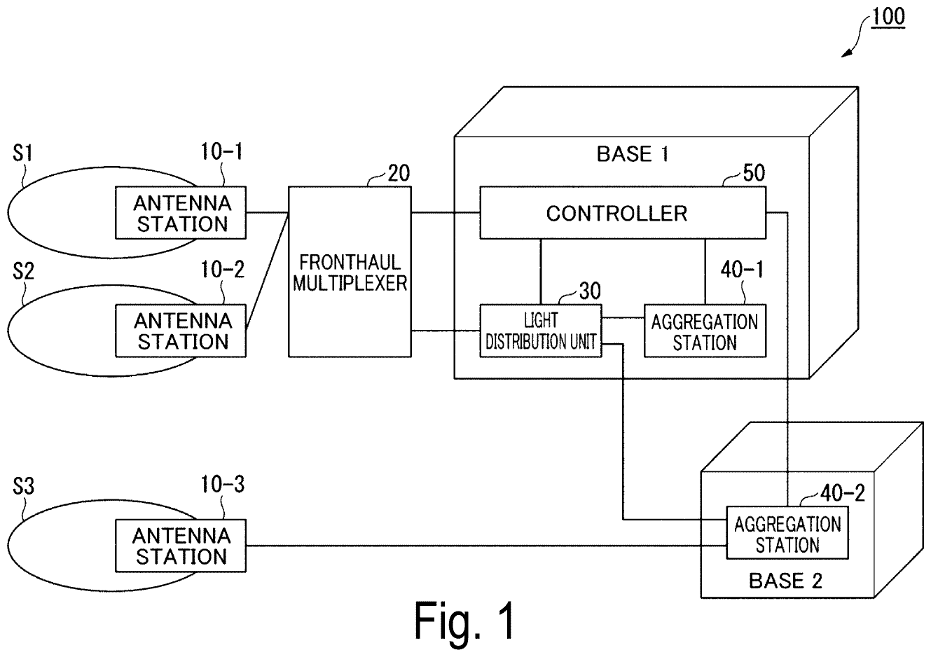

FIG. 1 is a diagram showing a configuration example of a communication system 100 in an embodiment. The communication system 100 includes one or more antenna stations 10, a fronthaul multiplexer 20, a light distribution unit 30, one or more aggregation stations 40, and a controller 50. Although FIG. 1 shows a case where the communication system 100 includes three antenna stations 10-1 to 10-3 and two aggregation stations 40-1 to 40-2, the number of antenna stations 10 and the number of aggregation stations 40 are not particularly limited.

In the following description, the antenna stations 10-1 to 10-3 are described as the antenna station 10 when they are not particularly distinguished from each other, and the aggregation stations 40-1 to 40-2 are described as the aggregation station 40 when they are not particularly distinguished from each other. Hereinafter, a direction from the antenna station 10 to the aggregation station 40 will be described as an uplink direction.

The antenna stations 10-1 and 10-2 and the fronthaul multiplexer 20 are connected to each other, the fronthaul multiplexer 20 and the light distribution unit 30 are connected to each other, the light distribution unit 30 and the aggregation stations 40-1 and 40-2 are connected to each other, and the antenna stations 10-3 and the aggregation station 40-2 are connected to each other by optical transmission lines. The optical transmission lines are, for example, optical fibers and transmit optical signals. The controller 50 and the fronthaul multiplexer 20 are connected to each other, the controller 50 and the light distribution unit 30 are connected to each other, and the controller 50 and the aggregation stations 40-1 and 40-2 are connected to each other by electric lines for transmitting electric signals.

In FIG. 1, the antenna stations 10-1 and 10-2 are accommodated in the fronthaul multiplexer 20, and the antenna station 10-3 is accommodated in the aggregation station 40-2. The fronthaul multiplexer 20 is accommodated in either the aggregation station 40-1 or the aggregation station 40-2 via the light distribution unit 30. The light distribution unit 30, the aggregation station 40-1, and the controller 50 are installed in a base 1, and the aggregation station 40-2 is installed in a base 2. The base 1 and the base 2 are installed in geographically distant places, respectively.

The antenna station 10 communicates with terminals located in cells S1, S2, and S3 representing a communicable range. The antenna station 10-1 communicates with, for example, a terminal located in the cell S1.

Similarly, the antenna stations 10-2 and 10-3 communicate with, for example, terminals located in the cells S2 and S3. The antenna station 10 receives uplink signals transmitted from terminals. The antenna station 10 is an RU in a mobile communications system. The antenna station 10 is one aspect of a terminal accommodating station.

The fronthaul multiplexer 20 operates in a such a manner that a plurality of connected antenna stations 10 can be seen as one antenna station 10 when viewed from the aggregation station 40. The fronthaul multiplexer 20 receives the uplink signals transmitted from the antenna stations 10. The fronthaul multiplexer 20 merges the uplink signals by performing signal processing on signals corresponding to the same time with respect to the received uplink signals. Thereby, the fronthaul multiplexer 20 generates a multiplex signal.

Furthermore, the fronthaul multiplexer 20 acquires, from the controller 50, information on a delay time to be imparted to the multiplex signal when switching connection to the aggregation station 40, which is a connection destination, so that a delay from the aggregation station 40 being connected does not change when the aggregation station 40, which is a connection destination, is switched. The fronthaul multiplexer 20 imparts a delay value indicated by the acquired delay time information to the multiplex signal at a timing when the aggregation station 40, which is a connection destination, is switched. Thereby, the fronthaul multiplexer 20 adjusts the transmission timing of the multiplex signal.

The light distribution unit 30 is a light distribution device that includes one or more first ports and a plurality of second ports, and outputs an optical signal, which is input from one port, from another port. The fronthaul multiplexer 20 is connected to the first port of the light distribution unit 30, and the aggregation stations 40-1 and 40-2 are connected to the second port of the light distribution unit 30. The light distribution unit 30 connects a first port to which the fronthaul multiplexer 20 is connected and a second port to which the aggregation station 40, which is an accommodation destination of the fronthaul multiplexer 20, is connected, under the control of the controller 50. Thereby, the light distribution unit 30 transfers the multiplex signal transmitted from the fronthaul multiplexer 20 to the aggregation station 40-1 or 40-2. The light distribution unit 30 may be an optical switch, a multicast switch, or other switches.

The aggregation station 40 processes the multiplex signal transferred from the light distribution unit 30 or transfers it to a higher order. Furthermore, the aggregation station 40 transitions to a sleep state in response to an instruction received from the controller 50. The sleep state is a function for achieving power saving by stopping some functions. The aggregation station 40 is a DU in the mobile communication system. The aggregation station 40-1 is one aspect of a first communication station, and the aggregation station 40-2 is one aspect of a second communication station. The aggregation station 40 is one aspect of a communication station.

The controller 50 controls the entire communication system 100. The controller 50 acquires determination information used for sleep control of the aggregation stations 40 from each of the plurality of aggregation stations 40. The determination information includes, for example, a traffic amount, the number of connected terminals, a traffic distribution amount, an allocation amount, radio quality information such as a channel quality indicator (CQI), priority information such as 5QI for communication, and information about contract services. Hereinafter, description will be given on the assumption that a determination material is a traffic amount.

When it is determined that an aggregation station 40 (hereinafter referred to as a “sleep target aggregation station”) that accommodates the fronthaul multiplexer 20 can be shifted to a sleep state on the basis of the determination information, the controller 50 instructs the light distribution unit 30 to perform switching. Further, the controller 50 notifies the fronthaul multiplexer 20 of information on a delay time. The controller 50 instructs the aggregation station 40, which is a sleep target, to sleep before or after the switching of the light distribution unit 30.

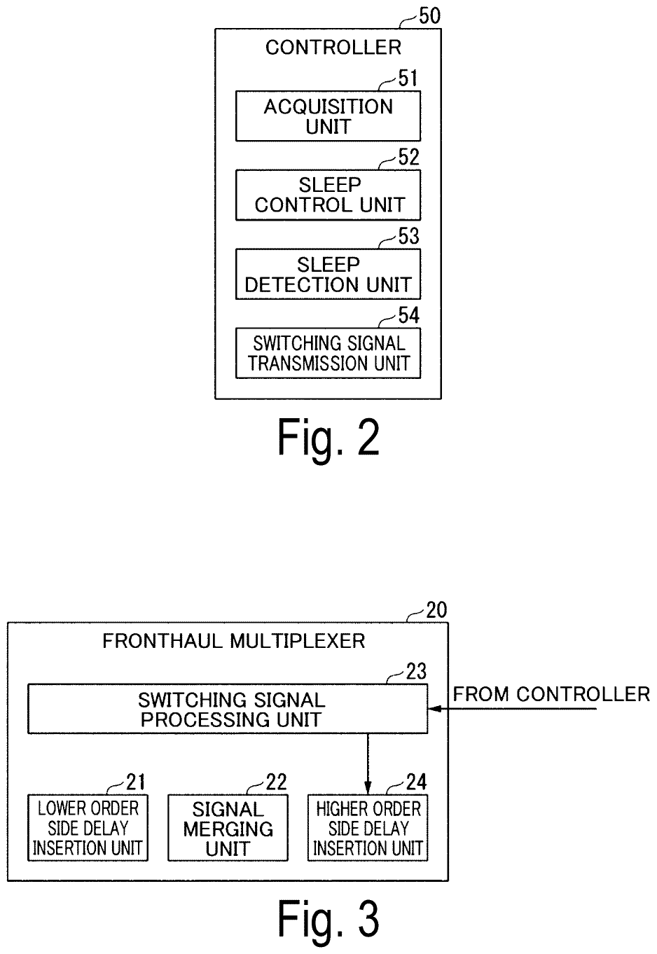

FIG. 2 is a diagram showing a configuration example of the controller 50 in the embodiment. The controller 50 includes an acquisition unit 51, a sleep control unit 52, a sleep detection unit 53, and a switching signal transmission unit 54.

The acquisition unit 51 acquires determination information from each of the plurality of aggregation stations 40. The acquisition unit 51 acquires, for example, determination information from each of the plurality of aggregation stations 40 at a predetermined timing or periodically. The acquisition unit 51 outputs the acquired determination information of each aggregation station 40 to the sleep control unit 52.

The sleep control unit 52 determines whether the aggregation station 40 can be set to be in a sleep state on the basis of the determination information of each aggregation station 40 which is acquired by the acquisition unit 51. The sleep control unit 52 determines, for example, whether the sleep target aggregation station can be set to be in a sleep state.

### Determination of Whether Sleep State Can Be Set When Determination Information Is Traffic Amount

When the determination information is a traffic amount, the sleep control unit 52 determines that a sleep target aggregation station can be set to be in a sleep state when a period in which the traffic amount of the sleep target aggregation station is less than a threshold value continues for a predetermined period or longer and when the other aggregation station 40 can accommodate the fronthaul multiplexer 20.

On the other hand, when the traffic amount of the sleep target aggregation station is equal to or greater than the threshold value, or when the other aggregation station 40 cannot accommodate the fronthaul multiplexer 20 even when the traffic amount of the sleep target aggregation station is less than the threshold value, the sleep control unit 52 determines that the sleep target aggregation station cannot be set to be in a sleep state.

### Determination of Whether Sleep State Can Be Set When Determination Information Is Number of Connected Terminals

When the determination information is the number of connected terminals, the sleep control unit 52 can determine that the sleep target aggregation station can be set to be in a sleep state when the number of connected terminals (for example, the number of antenna stations 10) of the sleep target aggregation station falls below a predetermined criterion and when the other aggregation station 40 can accommodate the connected terminals of the sleep target aggregation station.

On the other hand, the sleep control unit 52 determines that the sleep target aggregation station cannot be set to be in a sleep state when the number of connected terminals of the sleep target aggregation station is equal to or greater than a predetermined criterion. Alternatively, the sleep control unit 52 may determine that the sleep target aggregation station cannot be set to be in a sleep state when the other aggregation station 40 cannot accommodate the connected terminals of the sleep target aggregation station even when the number of connected terminals of the sleep target aggregation station falls below the predetermined criterion.

When it is determined that the sleep target aggregation station can be set to be in a sleep state, the sleep control unit 52 notifies the sleep detection unit 53 that the sleep target aggregation station is set to be in a sleep state. Further, the sleep control unit 52 transmits a sleep instruction to the sleep target aggregation station when it is determined that the sleep target aggregation station can be set to be in a sleep state. The sleep instruction is an instruction for executing a transition to a sleep state.

The sleep detection unit 53 detects a transition of the sleep target aggregation station to a sleep state in response to the notification received from the sleep control unit 52.

When the sleep detection unit 53 detects a transition of the sleep target aggregation station to a sleep state, the switching signal transmission unit 54 transmits a switching signal including an instruction to switch an accommodation designation of the fronthaul multiplexer 20 to the light distribution unit 30. The switching signal includes, for example, identification information of the aggregation station 40, which is a switching destination, and information indicating a switching timing. Further, the switching signal transmission unit 54 transmits a control signal including information on a delay time to the fronthaul multiplexer 20. The switching signal transmission unit 54 transmits a control signal including information indicating the switching timing of the light distribution unit 30 to the fronthaul multiplexer 20 when the sleep detection unit 53 detects a transition of the sleep target aggregation station to a sleep state.

The switching signal transmission unit 54 acquires information on a delay time to be imparted when connection is switched to another aggregation station 40 (for example, the aggregation station 40-2) so that a delay from the aggregation station 40 (for example, the aggregation station 40-1) to which the fronthaul multiplexer 20 is connected does not change. The switching signal transmission unit 54 acquires, for example, a difference between a first delay time required for transfer between the fronthaul multiplexer 20 and the aggregation station 40-1 and a second delay time required for transfer between the fronthaul multiplexer 20 and the aggregation station 40-2 as a delay time to be imparted. When three or more aggregation stations 40 are provided, the switching signal transmission unit 54 performs similar processing.

FIG. 3 is a diagram showing a configuration example of the fronthaul multiplexer 20 in the embodiment. The fronthaul multiplexer 20 includes a lower order side delay insertion unit 21, a signal merging unit 22, a switching signal processing unit 23, and a higher order side delay insertion unit 24.

The lower order side delay insertion unit 21 receives each uplink signal output from each of the plurality of antenna stations 10. The lower order side delay insertion unit 21 uses the received uplink signal to impart a delay to some uplink signals so that the uplink signals are received at the same time. For example, the lower order side delay insertion unit 21 imparts a delay corresponding to a distance difference to the uplink signal.

The signal merging unit 22 generates a multiplex signal by multiplexing each uplink signal including the uplink signal delayed by the lower order side delay insertion unit 21.

The switching signal processing unit 23 receives a control signal transmitted from the controller 50. The switching signal processing unit 23 acquires information on a delay time included in the received control signal and information indicating the switching timing of the light distribution unit 30. The switching signal processing unit 23 switches a delay value imparted by the higher order side delay insertion unit 24 on the basis of the switching timing of the light distribution unit 30. For example, the switching signal processing unit 23 switches the delay value so that the higher order side delay insertion unit 24 imparts the delay value indicated by the information on the delay time to the switching timing of the light distribution unit 30. By changing the delay value imparted by the higher order side delay insertion unit 24 simultaneously with the switching of the light distribution unit 30, it is possible to prevent link disconnection and communication interruption due to a delay time change between the aggregation station 40 and the antenna station 10 accompanying the switching of the aggregation station 40.

The higher order side delay insertion unit 24 imparts the delay value switched by the switching signal processing unit 23 to the multiplex signal output from the signal merging unit 22. The higher order side delay insertion unit 24 does not need to impart a delay to a term t when the switching signal processing unit 23 does not switch the delay value.

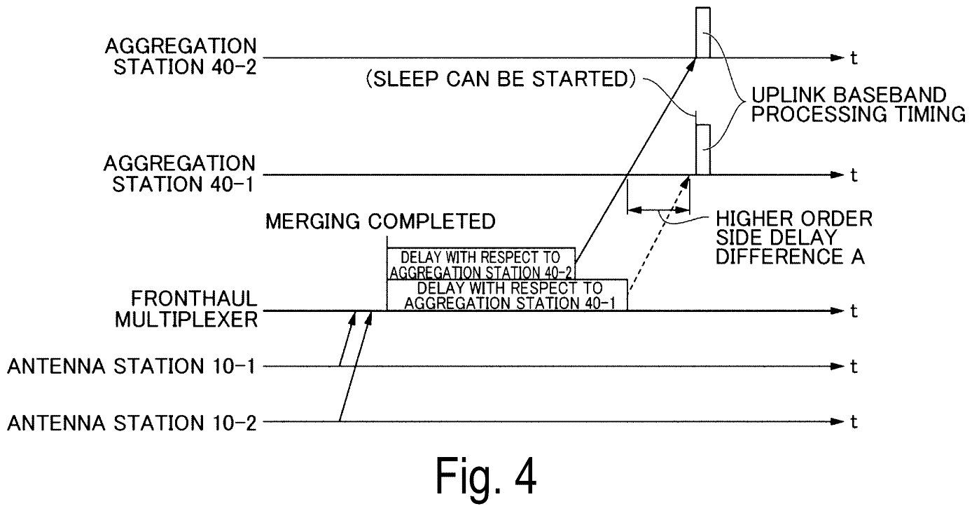

FIG. 4 is a diagram showing a method of calculating a delay time to be imparted in the embodiment. When a propagation delay occurs on the higher order side (between the fronthaul multiplexer 20 and the aggregation stations 40-1 and 40-2) as shown in FIG. 4, the switching signal transmission unit 54 acquires a propagation delay time difference (a higher order side delay difference A in FIG. 4) by calculating a difference between a first delay time required for transfer between the fronthaul multiplexer 20 and the aggregation station 40-1 and a second delay time required for transfer between the fronthaul multiplexer 20 and the aggregation station 40-2.

Then, in the fronthaul multiplexer 20, a propagation delay time difference is imparted to the multiplex signal and the multiplex signal is transmitted to the aggregation station 40-2 after switching. Even when switching to the aggregation station 40-2 subjected to baseband signal processing at the same timing as the aggregation station 40-1 is performed by time synchronization, the multiplex signal is transmitted just in time for the uplink baseband processing after the switching, and thus another propagation delay accompanying link disconnection is not required.

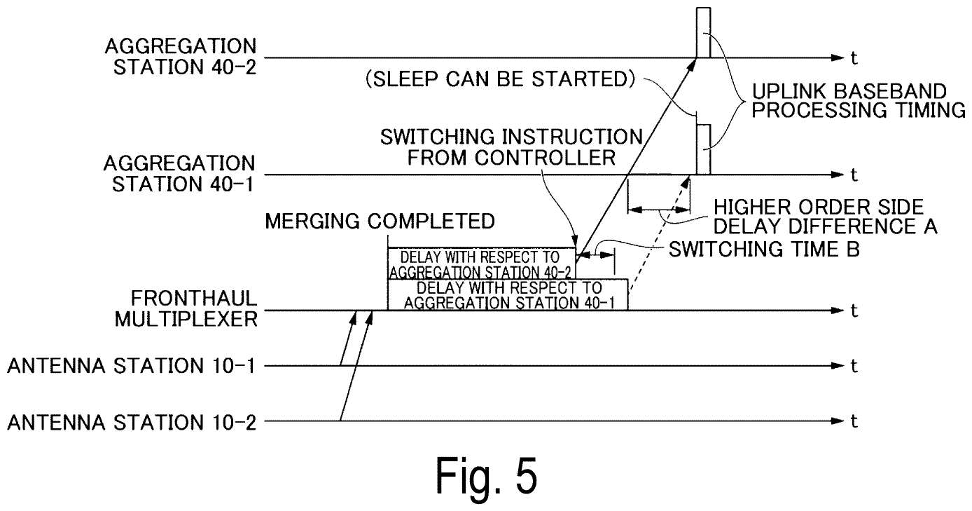

Further, as shown in FIG. 5, assuming that a distant aggregation station 40 (short insertion delay) is switched to a close distance aggregation station 40 (long insertion delay) at the time of aggregation, an additional insertion delay difference is matched to the switching timing of the light distribution unit 30, and thus it is possible to avoid a loss due to switching (when A>B). When A≤B, a loss can be reduced. A delay with respect to the aggregation station 40 may be set to 0, but when it is equal to or greater than a propagation time of a switching instruction from the controller 50, a delay difference and a switching time B are superimposed.

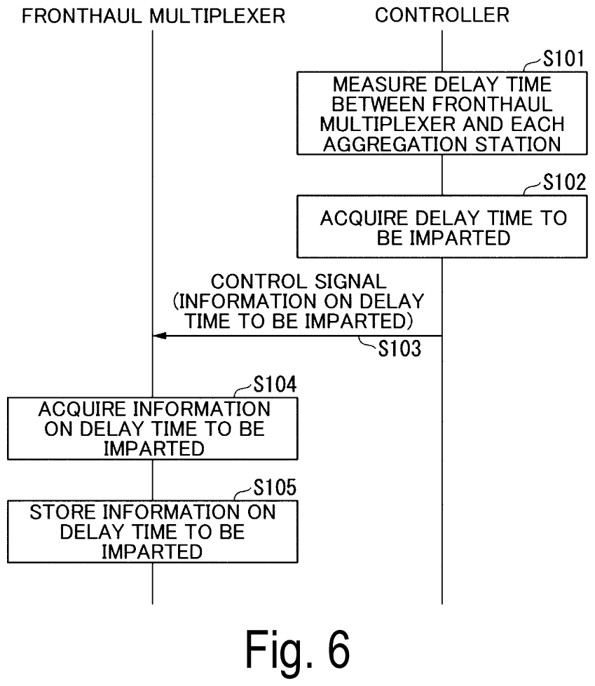

FIG. 6 is a sequence diagram showing a flow of pre-processing performed by the communication system 100 in the embodiment. Here, the pre-processing is processing for acquiring information on a delay time.

The switching signal transmission unit 54 of the controller 50 measures a delay time between the fronthaul multiplexer 20 and each aggregation station 40 (step S101). For example, the switching signal transmission unit 54 measures a first delay time between the fronthaul multiplexer 20 and the aggregation station 40-1 and a second delay time between the fronthaul multiplexer 20 and the aggregation station 40-2.

The switching signal transmission unit 54 uses the measured delay time between the fronthaul multiplexer 20 and each aggregation station 40 to acquire a delay time to be imparted when connection to another aggregation station 40 is switched so that a delay from the aggregation station 40 to which the fronthaul multiplexer 20 is connected does not change (step S102). Specifically, the switching signal transmission unit 54 acquires, as a delay time to be imparted, a difference value between a delay time (for example, a first delay time) of the aggregation station 40 to which the fronthaul multiplexer 20 is connected and a delay time (for example, a second delay time) of another aggregation station 40.

The switching signal transmission unit 54 notifies the fronthaul multiplexer 20 of a control signal including the acquired information on the delay time to be imparted (step S103). The switching signal processing unit 23 of the fronthaul multiplexer 20 acquires the control signal transmitted from the controller 50. The switching signal processing unit 23 acquires the information on the delay time to be imparted which is included in the acquired control signal (step S104). The switching signal processing unit 23 stores the acquired information on the delay time to be imparted in association with identification information of the aggregation station 40 (step S105).

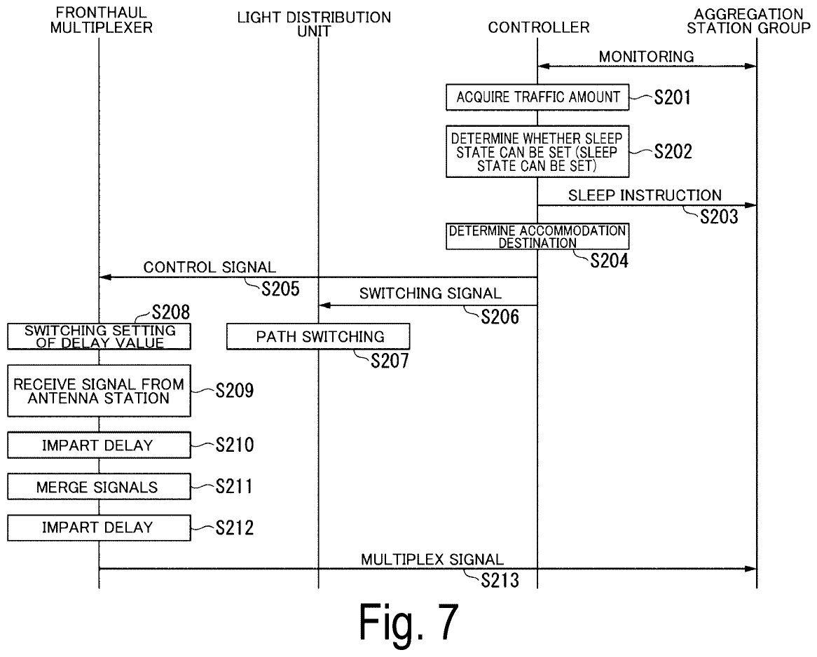

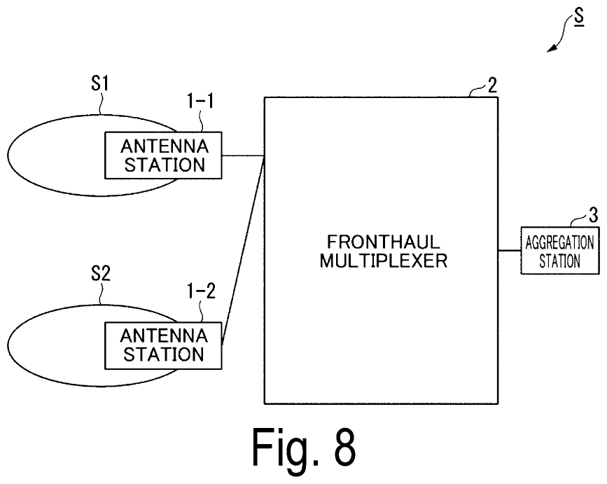

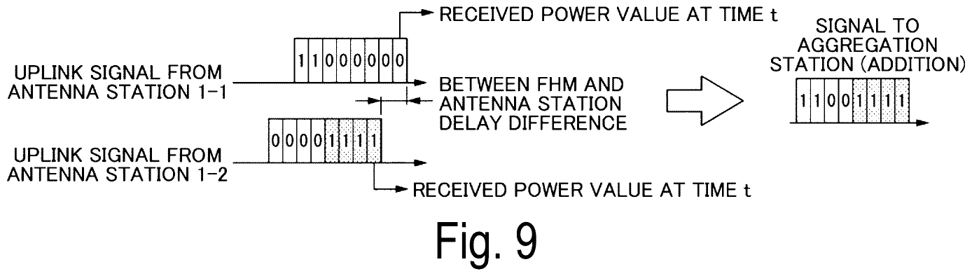

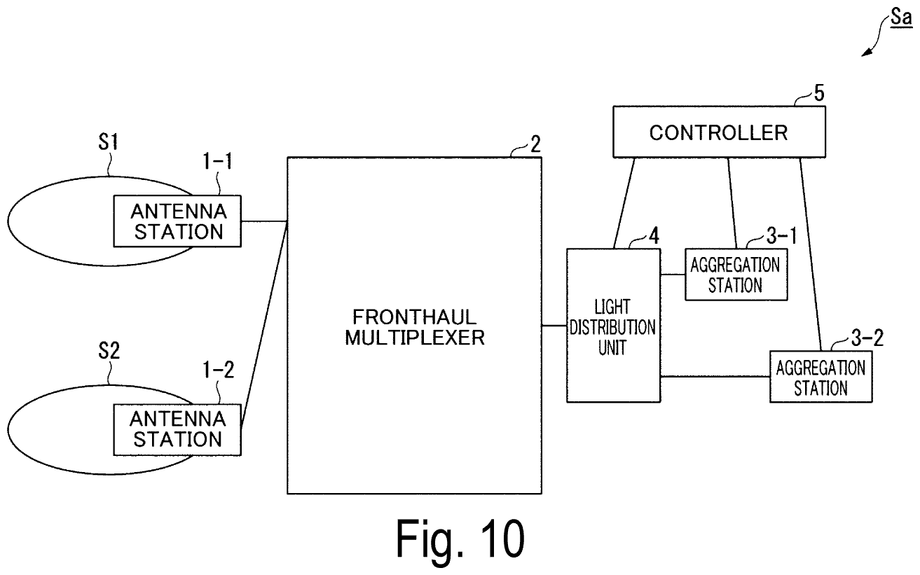

FIG. 7 is a sequence diagram showing a flow of a switching process performed by the communication system 100 in the embodiment. In FIG. 7, the aggregation stations 40-1 and 40-2 are described as an aggregation station group when they are not particularly distinguished from each other. At the start of the process shown in FIG. 7, it is assumed that the fronthaul multiplexer 20 is connected to the aggregation station 40-1 via the light distribution unit 30.

The acquisition unit 51 of the controller 50 acquires information on a traffic amount of each aggregation station 40 (step S201). The acquisition unit 51 outputs the acquired information on the traffic amount of each aggregation station 40 to the sleep control unit 52. The sleep control unit 52 determines whether each aggregation station 40 can be set to be in a sleep state on the basis of the information on the traffic amount of each aggregation station 40 which is output from the acquisition unit 51 (step S202). For example, it is assumed that the sleep control unit 52 determines that the aggregation station 40-1 can be set to be in a sleep state. In this case, the sleep control unit 52 transmits a sleep instruction to the aggregation station 40-1 (step S203). Thereby, the aggregation station 40-1 can be shifted to a sleep state.

When the aggregation station 40-1 is shifted to a sleep state before the light distribution unit 30 performs the switching, there is a possibility that a signal transmitted from the device connected to the aggregation station 40-1 (for example, the fronthaul multiplexer 20) will be lost. Consequently, the sleep control unit 52 may transmit a sleep instruction to the aggregation station 40-1 after the light distribution unit 30 performs the switching.

Further, the sleep control unit 52 notifies the sleep detection unit 53 that the aggregation station 40-1 is set to be in a sleep state. The sleep detection unit 53 detects the sleep state of the aggregation station 40-1 to which the fronthaul multiplexer 20 is currently connected, in response to the notification received from the sleep control unit 52. The sleep detection unit 53 determines the aggregation station 40, which is an accommodation destination of the fronthaul multiplexer 20 connected to the aggregation station 40-1, in accordance with the detection of the sleep state of the aggregation station 40-1 (step S204). Here, it is assumed that the sleep detection unit 53 determines the accommodation destination of the fronthaul multiplexer 20 connected to the aggregation station 40-1 as the aggregation station 40-2.

A method of determining the accommodation destination of the fronthaul multiplexer 20 is not particularly limited. For example, devices other than the fronthaul multiplexer 20 (for example, the antenna stations 10 that are not connected to the fronthaul multiplexer 20) have already been accommodated, and the aggregation station 40 capable of processing even when the fronthaul multiplexer 20 is accommodated may be determined as an accommodation destination of the fronthaul multiplexer 20. Thereby, a plurality of devices can be aggregated in one aggregation station 40.

The sleep detection unit 53 notifies the switching signal transmission unit 54 of information on the determined accommodation destination. The switching signal transmission unit 54 transmits a control signal including information indicating the switching timing of the light distribution unit 30 to the fronthaul multiplexer 20 in response to the notification received from the sleep detection unit 53 (step S205). Further, the switching signal transmission unit 54 transmits a switching signal to the light distribution unit 30 (step S206).

The light distribution unit 30 receives the switching signal transmitted from the controller 50. The light distribution unit 30 performs switching at a timing included in the switching signal (step S207). For example, the light distribution unit 30 performs switching to connect a first port to which the fronthaul multiplexer 20 is connected and a second port to which the aggregation station 40-2 is connected at a timing included in the switching signal.

The switching signal processing unit 23 of the fronthaul multiplexer 20 receives a control signal transmitted from the controller 50. The switching signal processing unit 23 sets a delay value indicated by information on a delay time to the higher order side delay insertion unit 24 at the switching timing of the light distribution unit 30 included in the control signal (step S208). Thereby, a delay value is switched such that the higher order side delay insertion unit 24 imparts the delay value indicated by the information on the delay time.

The lower order side delay insertion unit 21 of the fronthaul multiplexer 20 receives each uplink signal output from each of the plurality of antenna stations 10 (step S209). The lower order side delay insertion unit 21 inserts a delay into some of the received uplink signals (step S210). The insertion of the delay is the same as in the related art. The lower order side delay insertion unit 21 outputs each uplink signal including the delayed uplink signal to the signal merging unit 22.

The signal merging unit 22 generates a multiplex signal by multiplexing each uplink signal including the uplink signal delayed by the lower order side delay insertion unit 21 (step S211). The signal merging unit 22 outputs the generated multiplex signal to the higher order side delay insertion unit 24. The higher order side delay insertion unit 24 imparts a delay value set by the switching signal processing unit 23 to the multiplex signal output from the signal merging unit 22 (step S212). Thereafter, the higher order side delay insertion unit 24 outputs the multiplex signal to the light distribution unit 30 after the lapse of a delay time corresponding to the delay value (step S213). Thereby, the multiplex signal input to the light distribution unit 30 is transferred to the aggregation station 40-2 which is a new accommodation destination.

According to the communication system 100 configured as described above, the controller 50 includes the switching signal transmission unit 54 that transmits a switching signal to the light distribution unit 30 and transmits a control signal, which includes information on a delay time to be imparted to a multiplex signal by the fronthaul multiplexer 20, to the fronthaul multiplexer 20 so that the delay time does not change before and after the switching of the aggregation station 40. The fronthaul multiplexer 20 includes the switching signal processing unit 23 that acquires information on a delay time to be imparted to a multiplex signal included in a control signal from the controller 50 in advance, and switches a delay value to be imparted to the multiplex signal at the switching timing of the light distribution unit 30, and the higher order side delay insertion unit 24 that imparts the delay value switched by the switching signal processing unit 23 to the multiplex signal. Thereby, even when the connection destination of the fronthaul multiplexer 20 is changed to a different aggregation station 40, link disconnection does not occur or a disconnection time can be shortened.

In the communication system 100, a power saving means can be applied to a case where the power saving means such as the sleep of the aggregation station 40 cannot be applied because an allowable disconnection time is limited.

It can be expected that the controller 50 issues information on a delay time imparted in the fronthaul multiplexer 20 to economically achieve this function by utilizing the existing fronthaul multiplexer 20.

### Modification Example 1

The controller 50 may be configured to cancel the sleep state of the aggregation station 40 that is in a sleep state. Here, it is assumed that the aggregation station 40-1 is in a sleep state. The sleep control unit 52 determines, for example, whether it is necessary to cancel the sleep state of the aggregation station 40-1 on the basis of determination information acquired from the aggregation station 40-2 that is not in a sleep state. The sleep control unit 52 determines that it is necessary to cancel the sleep state of the aggregation station 40-1 when a traffic amount of the aggregation station 40-2 that is not in a sleep state is set to be a predetermined threshold value (for example, 50% of a traffic amount that can be processed by the aggregation station 40-2) or more.

On the other hand, the sleep control unit 52 determines that it is not necessary to cancel the sleep state of the aggregation station 40-1 when a traffic amount of the aggregation station 40-2 that is not in a sleep state is less than a predetermined threshold value (for example, 50% of a traffic amount that can be processed by the aggregation station 40-2). Although a case where determination information is a traffic amount has been described here, determination based on other determination criteria is performed when other information is used as determination information.

When the sleep control unit 52 determines that it is necessary to cancel a sleep state, the sleep control unit 52 notifies the sleep detection unit 53 that the sleep state of the aggregation station 40-1 is cancelled. Further, when the sleep control unit 52 determines that it is necessary to cancel a sleep state, the sleep control unit 52 transmits a sleep cancellation instruction to the aggregation station 40-1 that is in a sleep state. The sleep cancellation instruction is an instruction to execute a return from the sleep state. The aggregation station 40-1 returns from the sleep state in response to the reception of the sleep cancellation instruction transmitted from the controller 50.

The sleep detection unit 53 detects the sleep cancellation of the aggregation station 40-1 that is in a sleep state in response to the notification indicating the sleep cancellation from the sleep control unit 52. When the sleep detection unit 53 detects the sleep cancellation of the aggregation station 40-1 that is in a sleep state, the switching signal transmission unit 54 transmits a switching signal including an instruction to switch the accommodation destination of the fronthaul multiplexer 20 to the light distribution unit 30. In this case, the switching signal transmission unit 54 transmits, to the light distribution unit 30, a switching signal including an instruction to switch the accommodation destination of the fronthaul multiplexer 20 to the aggregation station 40-1 returning from the sleep state.

Further, when the sleep detection unit 53 detects the sleep cancellation of the aggregation station 40-1 that is in a sleep state, the switching signal transmission unit 54 transmits a control signal including information indicating the switching timing of the light distribution unit 30 to the fronthaul multiplexer 20. The switching signal processing unit 23 of the fronthaul multiplexer 20 receives the control signal transmitted from the controller 50. The switching signal processing unit 23 sets a delay value to be set in the higher order side delay insertion unit 24 to the delay value before the switching on the basis of the received control signal. For example, the switching signal processing unit 23 switches the delay value so that the higher order side delay insertion unit 24 imparts a delay value indicated by delay time information at the switching timing of the light distribution unit 30. Thereby, the state can be switched back to the state before the switching.

### Modification Example 2

The communication system 100 may be configured to include a wireless controller that wirelessly communicates with the aggregation station 40. In such a configuration, the wireless controller includes the acquisition unit 51 and the sleep control unit 52 included in the controller 50, and the controller 50 does not include the acquisition unit 51 and the sleep control unit 52. When the sleep control unit 52 of the wireless controller determines that a sleep state can be set, the sleep control unit 52 notifies the controller 50 that a sleep target aggregation station is set to be in a sleep state. The sleep detection unit 53 of the controller 50 detects a transition of the sleep target aggregation station to a sleep state in response to the notification received from the wireless controller. Subsequent processing is the same as that in the above-described embodiment.

Some or all of the functional units of at least the fronthaul multiplexer 20 and the controller 50 are implemented as software by causing a processor such as a central processing unit (CPU) to execute programs stored in a storage device and a storage unit including a non-volatile recording medium (non-transitory recording medium). The programs may be recorded on a computer-readable non-transitory recording medium. The computer-readable non-transitory recording medium is, for example, a non-temporary recording medium such as a portable medium such as a flexible disk, a magneto-optical disc, a read only memory (ROM), or a compact disc read only memory (CD-ROM), or a storage device such as a hard disk built into a computer system.

Some or all of the functional units of at least the fronthaul multiplexer 20 or some or all of the functional units of the controller 50 may be implemented using, for example, hardware including electronic circuits or circuitry using a large scale integrated (LSI) circuit, an application specific integrated circuit (ASIC), a programmable logic device (PLD) or a field programmable gate array (FPGA), or the like.

Although the embodiment of the present invention has been described in detail with reference to the drawings, a specific configuration is not limited to this embodiment, and design within the scope of the gist of the present invention, and the like are included.

### INDUSTRIAL APPLICABILITY

The present invention is applicable to a communication system including a fronthaul multiplexer.

### REFERENCE SIGNS LIST

10, 10-1 to 10-3 Antenna station
20 Fronthaul multiplexer
21 Lower order side delay insertion unit
22 Signal merging unit
23 Switching signal processing unit
24 Higher order side delay insertion unit
30 Light distribution unit
40, 40-1 to 40-2 Aggregation station
50 Controller
51 Acquisition unit
52 Sleep control unit
53 Sleep detection unit
54 Switching signal transmission unit
100 Communication system

1. A control device comprising:
a switching signal transmitter configured to transmit, to a light distributor, a switching signal including an instruction to switch an accommodation destination of a fronthaul multiplexer from a first communication station to a second communication station, and transmit, to the fronthaul multiplexer, a control signal including information on a delay time to be imparted to a multiplex signal by the fronthaul multiplexer so that a delay time does not change between before and after the switching of the communication station, the fronthaul multiplexer outputting the multiplex signal, which is obtained by multiplexing signals output from a plurality of terminal accommodation stations communicating with a terminal by adjusting timings of the signals, to a distribution destination via a light distributor.

2. The control device according to claim 1, wherein the switching signal transmitter acquires, as a delay time to be given to the multiplex signal, a difference between a first delay time required for transfer between the fronthaul multiplexer and the first communication station and a second delay time required for transfer between the fronthaul multiplexer and the second communication station.

3. The control device according to claim 1, wherein the switching signal transmitter further includes, in the control signal, information on a timing at which the switching is started in the light distributor.

4. The control device according to claim 1, further comprising a sleep detector configured to detect a transition of the communication station to a sleep state,
wherein, when the sleep detector detects a transition of the communication station to a sleep state, the switching signal transmitter unit transmits the switching signal to the light distributor and transmits the control signal to the fronthaul multiplexer.

5. The control device according to claim 4, further comprising:
an acquirer configured to acquire determination information used for sleep control of the communication station from each of the plurality of communication stations; and
a sleep controller configured to determine whether the communication station is able to be set to be in a sleep state, based on the determination information acquired by the acquirer,
wherein the sleep detector detects a transition of the communication station to a sleep state based on a determination result of the sleep controller.

6. A fronthaul multiplexer in a communication system including a plurality of terminal accommodation stations that communicate with a terminal, the fronthaul multiplexer that outputs a multiplex signal obtained by multiplexing signals by adjusting timings of the signals output from the plurality of terminal accommodation stations, and a light distributor that outputs the multiplex signal output from the fronthaul multiplexer to a distribution destination, the fronthaul multiplexer comprising:
a lower order side delay inserter unit configured to adjust transmission timings of signals output from each of the plurality of terminal accommodation stations;
a signal merger configured to generate the multiplex signal by multiplexing the signals adjusted by the lower order side delay inserter;
a switching signal processor configured to receive, from the outside, a control signal including information on switching of the light distributor and information on a delay time to be imparted to the multiplex signal, and switch a delay value indicated by the information on the delay time to be imparted to the multiplex signal included in the control signal to a delay value to be imparted to the multiplex signal in response to the reception of the control signal; and
a higher order side delay inserter configured to impart the delay value switched by the switching signal processor to the multiplex signal.

7. A connection switching method comprising:
transmitting, to a light distributor a switching signal including an instruction to switch an accommodation destination of a fronthaul multiplexer from a first communication station to a second communication station, and transmitting, to the fronthaul multiplexer, a control signal including information on a delay time to be imparted to a multiplex signal by the fronthaul multiplexer so that a delay time does not change before and after the switching of the communication station, the fronthaul multiplexer outputting the multiplex signal, which is obtained by multiplexing signals output from a plurality of terminal accommodation stations communicating with a terminal by adjusting timings of the signals, to a distribution destination via a light distributor.

8. (canceled)
